(19) United States
(12) Patent Application Publication
(10) Pub. No.: US 2001/0043299 A1
(43) Pub. Date: Nov. 22, 2001

(54) LIQUID CRYSTAL DISPLAY HAVING HOLOGRAPHIC DIFFUSER FOR PRECONDITIONING LIGHT INCIDIENT UPON A LIQUID CRYSTAL MEDIUM

(76) Inventors: CHARLES M. PETERSON, REDMOND, WA (US); THOMAS A. SEDER, CEDAR RAPIDS, IA (US)

Correspondence Address: ATTENTION KYLE EPPELE, ROCKWELL COLLINS INC, 400 COLLINS ROAD N E, CEDAR RAPIDS, IA, 52498

(21) Appl. No.: 09/300,761

(22) Filed: Apr. 26, 1999

(51) Int. Cl. G02F 1/1333

(52) U.S. Cl. 349/122

(57) ABSTRACT

A twisted nematic liquid crystal display utilizes a premodifying or contouring circuit to provide inverse characteristics of the LCD. The contouring circuit compensates for the non-Lambertian characteristics of the liquid crystal display. This system provides a superior contrast ratio, gray-scale performance and stable chromaticity. The contour circuit can include a holographic diffuser.

### BACKGROUND OF THE INVENTION

In conventional display systems, such as liquid crystal display (LCD) systems, gray scale performance and contrast ratio degrade significantly as viewing angle is increased. For example, in uncompensated twisted nematic LCD systems, contrast ratio and gray scale performance degrade due to differences in phase retardation induced in an off-axis ray as the ray traverses the liquid crystal medium when energized to the white and black states.

In general, it is desirous to provide improved contrast and gray scale luminance linearity performance over the field of view of conventional displays. These characteristics are particularly important in avionic display systems and other high-definition viewing applications.

In conventional display systems, such as, LCDs, a matrix of pixels is controlled by electric signals to provide a static or a dynamic graphic image. If the display is a color display, each pixel can be comprised of a red element, a green element, and a blue element. The element can include a single liquid crystal domain or a dual liquid crystal domain. The supra-molecular architecture of the liquid crystal is controlled by a thin-film transistor (TFT). The architecture is a collection of nematic molecules that are manipulated by electric signals provided by the thin-film transistors. Using the TFT to energize the liquid crystal cell, the architecture of the liquid crystal molecules changes and a particular chosen amount of light can be transmitted through its associated element.

As shown in FIG. 1, a conventional full-color, single domain display 100 includes a polarizer 105, an analyzer 110, a liquid crystal cell 115, and one or more compensator layers 120. Liquid crystal cell 115 includes an active matrix substrate 125, a color filter substrate 130, and liquid crystal material 135. Polarizer 105 and analyzer 110 both transmit only one polarization state of electromagnetic energy. However, the term “polarizer” typically refers to a polarizer element that is closest to the source of light, while the term “analyzer” refers to a polarizer element that is closest to a viewer of the LCD. Light from a Lambertion light source is provided through display 100 to show images.

Substrate 125 includes an array of TFTs, transparent electrodes, address lines, and an alignment layer. The address lines activate individual liquid crystal display elements via the TFTs. The color matrix substrate 130 can include a black matrix coating, a color filter matrix, a transparent electrode, and an alignment layer. The alignment layers on active matrix substrate 125 and the color matrix substrate layer 130 act in combination to induce twisted nematic orientation in liquid crystal material 135.

The total cell retardation, δnd, is angle-dependent, and a degree of elipticity is induced in the off-axis light because twisted pneumatic LCD cells, such as, cell 115, are “tuned” such that linearly polarized rays that enter and traverse normal to the LCD cell emerge as linearly polarized rays (zero net induced retardation). However, liquid crystal modules in the LCD cells exhibit birefringence (i.e., the index of refraction, n, varies with the polarization state of the ray relative to the molecular axis). Thus, the polarization state of off-axis light is elliptical in an uncompensated system that is tuned for linear polarization incident normal to analyzer 110. In these systems the black state luminance is high off-axis and the contrast ratio is low. Similarly, gray-scale luminescent in such a system will vary wildly over the viewing angle.

Further still, since the total cell retardation, δnd, is wavelength-dependent, the color stability of the display output is strongly influenced by viewing angle. Additionally, gray scale levels are achieved by operating the LCD cell such that the average molecule has a symmetry (orientation) between the molecule full-on and full-off configuration. The total cell retardation, δnd, is a function of gray scale level. Gray-scale level refers to the lightness of a color element associated with the display system (e.g., the orientation of the liquid crystal molecule between the full-on and full-off configuration).

With reference to FIG. 2, a conventional twisted nematic active matrix liquid crystal displays (TN-AMLCD) Lambertian light input distribution 10 for a LCD, such as, display 100 is shown. A Lambertian light source provides light which has an intensity that varies with respect to viewing angle (e.g., I=Io cos θ, where θ is the viewing angle). Distribution 10 further indicates that the Lambertian input light distribution provides red, blue, and green light which have the same characteristics across viewing angles (e.g., symmetrical). As the Lambertian light input distribution 10 is provided through a conventional liquid crystal display, such as, display 100 (FIG. 1), display 100 transforms distribution 10 to output light distribution 20 (FIG. 3). As can be seen in FIG. 3, (e.g., portions 22 and 24) the field of view luminance is a strong function of viewing angle. Consequently, the contrast ratio and gray scale performance varies with respect to viewing angle. Additionally, the distributions for red, blue, and green light differ considerably.

Thus, there is a need for a liquid crystal display system which has an increased contrast ratio and linearized gray scale performance and stable chromaticity over its field of view. Further still, there is a need for a twisted nematic liquid crystal display system having compensated contrast ratio and gray scale performance.

### SUMMARY OF THE INVENTION

The present invention relates to a twisted nematic liquid crystal display system. The liquid crystal display system includes a Lambertian light source, a color liquid crystal cell having a particular output distribution, a first polarizer, a second polarizer disposed in front of the liquid crystal cell, and a holographic diffuser. The holographic diffuser is disposed between the first polarizer and the light source. The diffuser is tuned to contour the light from the Lambertian light source in a manner that is exactly complementary to the contouring imparted to a Labertian source by the liquid crystal cell alone.

The present invention further relates to a liquid crystal display system including a light source, a color liquid crystal cell, and a means for contouring light. The liquid crystal cell has a-response and is disposed in front of a light source. The means for contouring light contours the light inversely to the response of the liquid crystal cell. The liquid crystal display system thereby provides a Lambertian response due to the operation of the means for contouring.

The present invention further still relates to a method of optimizing a field of view of a color liquid crystal display. The method includes providing light from a light source, contouring light distribution of the light in accordance with an inverse of characteristics of a liquid crystal cell, and providing the light distribution through the liquid crystal cell. The output light distribution from the liquid crystal cell is Lambertian.

### BRIEF DESCRIPTION OF THE DRAWINGS

The present invention will hereafter be described with reference to the accompanying drawings, wherein like numerals denote like elements and:

FIG. 1 is a schematic block diagram of a conventional liquid crystal display system;

FIG. 2 is a schematic diagram of an input light distribution for the conventional liquid crystal display system illustrated in FIG. 1;

FIG. 3 is an output light distribution for the conventional liquid crystal display system illustrated in FIG. 1;

FIG. 4 is a schematic block diagram of a liquid crystal display system in accordance with an exemplary embodiment of the present invention;

FIG. 5 is a schematic drawing of input light distribution in accordance with another exemplary embodiment of the present invention for the liquid crystal display system illustrated in FIG. 4; and

FIG. 6 is a schematic drawing of the output light distribution in accordance with still another exemplary embodiment of the present invention for the liquid crystal display system illustrated in FIG. 3.

### DETAILED DESCRIPTION OF PREFERRED EXEMPLARY EMBODIMENTS

With reference to FIG. 4, a display system 50 includes a light source 52, a contour apparatus 54, and a liquid crystal display (LCD) unit 56. Unit 56 can be a twisted nematic, active matrix liquid crystal display cell that is normally black or normally white. Unit 56 generally includes a polarizer, a compensator, a liquid crystal cell, and an analyzer.

Display 56 is preferably a color display system. Source 52 is a Lambertian light source. Contour apparatus 54 can be a holographic diffuser. The holographic diffuser includes a medium which provides compensation. The medium can be etched in accordance with the compensation scheme.

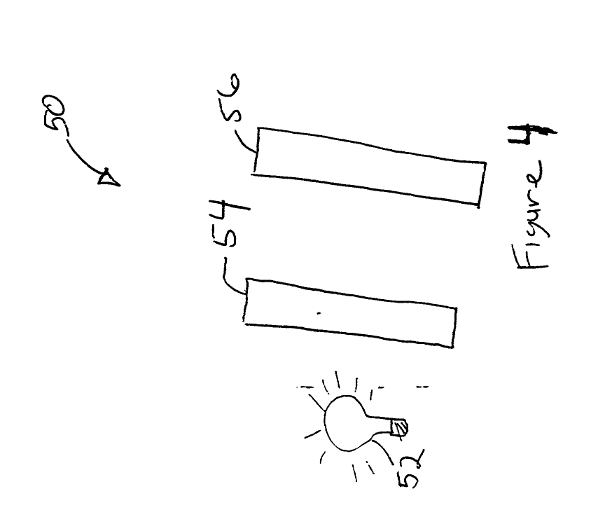

With reference to FIGS. 4 and 5, light source 52 is a Lambertian light source having an intensity response for all three colors, where I=Io cos θ, where θ is the field of view (e.g., intensity falls as viewing angle is increased). Generally, the light distribution from source 52 is similar to distribution 10 (FIG. 2). Light source 52 is preferably a fluorescent light source including the colors red, green and blue. Light source 52 can include a prism for directing the light.

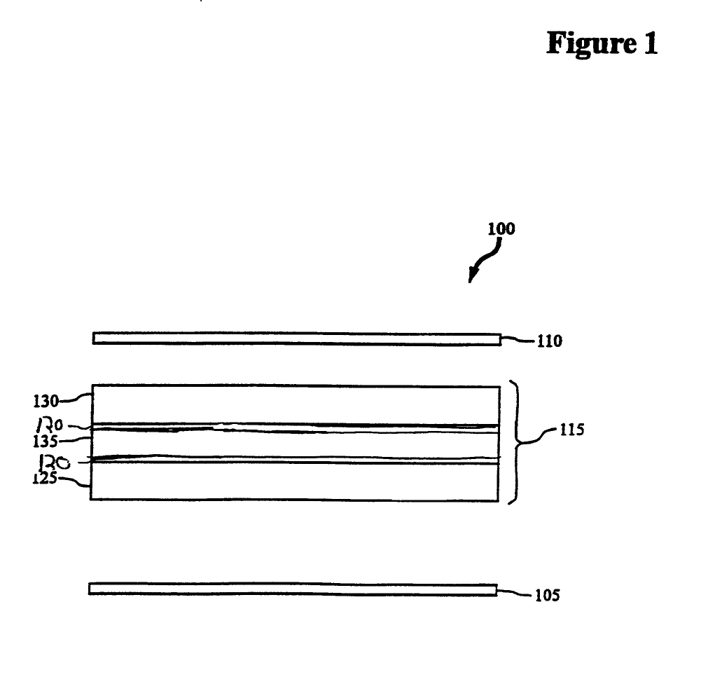

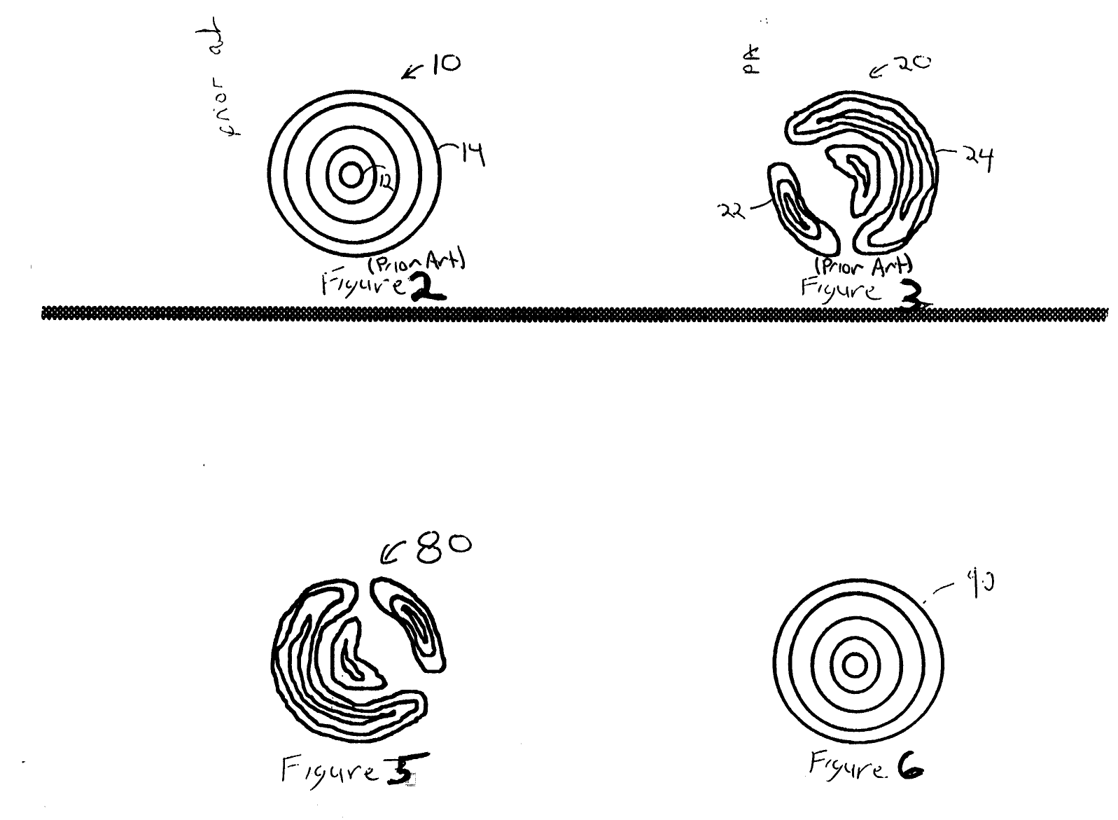

Contour apparatus 54 premodifies or contours the Lambertian light from source 52 to a non-Lambertian distribution 80, as shown in FIG. 5. Non-Lambertian distribution 80 preferably has the opposite, complement, or inverse of the characteristics of display unit 56. Assuming unit 56 has the same characteristics as cell 115 (FIG. 1), distribution 80 is the inverse of distribution 20 (FIG. 3). Therefore, apparatus 54 provides a non-Lambertian distribution 80 for red, green, and blue light to display 56.

As shown in FIG. 5, distribution 80 is highly asymmetric for all three colors, thereby reflecting that the total cell retardation, δnd, is angle and wavelength dependent. Providing the inverse or negative output observed for a Lambertian input for display unit 56 allows the output of display 56 to be Lambertian, as shown in FIG. 6. Therefore, when apparatus 54 is utilized, a specifically contoured intensity distribution, such as, distribution 80, is input to display unit 56, and display unit 56 provides a Lambertian output distribution 90 (FIG. 5). Distribution 90 is similar to distribution 10 (FIG. 1), e.g., the particular gray scale luminance is by definition constant as a function of viewing angle. In addition to increasing the usable viewing angle, chromatically stability is also enhanced using apparatus 54 due to stabilize luminance at compensated viewing angles. For example, if display unit 56 has a characteristic where a southern hemisphere of the field of view is biased green and a northern hemisphere of the field of view is biased blue, contour apparatus 54 can prebias the light opposite to those characteristics. In this example, the southern hemisphere would have a reduced green response and the northern hemisphere would have a reduce blue response. Such a scheme allows system 50 to have an unbiased output over the field of view.

An intermediate gray-scale level is chosen for the programming of apparatus 54 so the response is appropriate for most gray-scale levels. For example, by choosing level 4, neighboring gray scale levels such as gray scale levels 5 and 3 are relatively stable.

Preferably, apparatus 54 is a holographic diffuser which has a medium that is written so unit 56 provides the appropriate output distribution, such as, distribution 90. The medium is configured to transform the distribution of source 52 to distribution 80. To configure apparatus 54, cell 56 is characterized and the complement is written to apparatus 54.

It is understood that, while the detailed drawings, specific examples and particular components given describe preferred exemplary embodiments of the present invention, they are for the purpose of illustration only. The apparatus and method of the present invention are not limited to the precise details disclosed. For example, although a holographic diffuser is shown, any type of precontouring device could be utilized. Thus, changes can be made to the preferred embodiments without departing from the scope of the invention, which is defined by the following claims.

What is claimed is:

1. A twisted nematic liquid crystal display system having a field of view, the liquid crystal display system comprising:
a Lambertian light source;
a first polarizer;
a color liquid crystal cell having a particular output distribution;
a second polarizer disposed in front of the liquid crystal cell; and
a holographic diffuser disposed between the first polarizer and the second polarizer, whereby the diffuser is tuned to contour the light from the Lambertian light source in accordance with an inverse of the output distribution.

2. The liquid crystal display system of claim 1, wherein the holographic diffuser includes a laser-encoded medium, the medium complementing the off-axis phase retardation induced by the liquid crystal medium.

3. The liquid crystal display system of claim 1, wherein the display system is a normally white display.

4. The liquid crystal display system of claim 1, wherein the display system is a normally black display.

5. The liquid crystal display system of claim 1, wherein the holographic diffuser is disposed between the Lambertian light source and the liquid crystal cell.

6. The liquid crystal display system of claim 5, wherein the holographic diffuser is a laser written film.

7. The liquid crystal display system of claim 1, wherein the display system is an avionic display, and the field of view has an oval shape.

8. A liquid crystal display system, comprising:
a light source;
a color liquid crystal cell having a response and disposed in front of the light source; and
means for contouring light from the light source inversely to the response, whereby the liquid crystal display system provides a Lambertian output.

9. The liquid crystal display system of claim 8, wherein means for contouring light is a holographic diffuser disposed in front of the liquid crystal cell.

10. The liquid crystal display system of claim 8, wherein the liquid crystal display system has an oval field of view.

11. The liquid crystal display of claim 9, wherein the holographic diffuser includes an etched medium.

12. The liquid crystal display system of claim 11, wherein the liquid crystal cell includes a polarizer and an analyzer.

13. The liquid crystal display system of claim 9, wherein the holographic diffuser is configured to correct field of view limitations of the liquid crystal cell.

14. The liquid crystal display system of claim 13, wherein the display is an avionic display.

15. A method of optimizing a field of view of a color liquid crystal display, the method comprising:
providing a light from a light source;
contouring light distribution of the light in accordance with an inverse of characteristics of a liquid crystal cell;
providing the light distribution through the liquid crystal cell, whereby output light distribution from the liquid crystal cell is Lambertian.

16. The method of claim 15, wherein the optimized field of view has an oval shape.

17. The method of claim 16, wherein the contouring step is performed by a holographic diffuser.

18. The method of claim 17, wherein the holographic diffuser is in front of the liquid crystal cell and after the light source.

19. The method of claim 15, wherein the liquid crystal display system is color.

20. The method of claim 15, wherein the light source is a Lambertian light source.
